(19) United States
(12) Patent Application Publication
(10) Pub. No.: US 2005/0235225 A1
(43) Pub. Date: Oct. 20, 2005

(54) Selectable commands for displaying user interface panels

(76) Inventors: Aurobinda Pradhan, Bangalore (IN); Durga Prasad Vemula, Bangalore (IN)

Correspondence Address: FISH & RICHARDSON, P.C., PO BOX 1022, MINNEAPOLIS, MN, 55440-1022, US

(21) Appl. No.: 10/827,496

(22) Filed: Apr. 19, 2004

(51) Int. Cl. G06F 3/00

(52) U.S. Cl. 715/811; 715/745; 715/789

(57) ABSTRACT

A panel previously displayed on a graphical user interface can be displayed again, according to a method that involves displaying a selected panel on a graphical user interface; receiving, while the selected panel is being displayed, a first user input to create a user-selectable command for displaying the selected panel, the user-selectable command thereafter being displayed in a menu; and receiving a second user input upon a first selection of the user-selectable command, wherein the user-selectable command ceases to be displayed in the menu upon receipt of the second user input. A user-selectable command may be displayed in a menu and disappear upon a predetermined event other than being deleted by a user.

### TECHNICAL FIELD

This description relates to user-selectable commands for displaying panels in a graphical user interface.

### BACKGROUND

Graphical user interfaces used with various existing computer systems typically allow users to view or enter information or data. For example, a graphical user interface may provide that a user can work with documents from word processing programs, database information, data output from application programs, and Internet content such as pages from the world wide web. What is displayed in the graphical user interface may generally be referred to as a panel, and panels may provide for data input, data output, or both.

A user sometimes navigates in a graphical user interface from one panel to another panel, and then to a third panel, and so on. Moreover, a user sometimes needs to return to a previously displayed panel. However, it can be difficult for the user to find the previous panel, particularly if the user is required to remember and enter an address location for the desired panel.

One existing feature is the so-called Favorites menu of the Internet Explorer (IE) web browser from Microsoft. While a page is being displayed in IE, a user can open the Favorites menu and select therein an “Add to Favorites . . . ” command. This adds a command to the Favorites menu for displaying the specific page. At a later time, perhaps when another page is being displayed in IE, the user can again open the Favorites menu and select the stored Favorite to have the previously displayed page be displayed. Created favorites may remain indefinitely in the Favorites menu and the user can edit the list of Favorites by first selecting an “Organize Favorites” command.

IE also includes an “Address bar”, which is an input field wherein the user can type an address to a desired page. IE saves the address information. When the user begins typing a previously entered address in the address box, IE may recognize the address and “autocomplete” the entry by providing the remainder of the address characters. Moreover, previously entered addresses can be viewed in a drop-down list box under the address field. The user can clear the entries from this list box by executing a “Clear History” command. If, in contrast, the user navigates to a page by clicking on a hyperlink to that page instead of typing in the address bar, the page's address will not be included in the list of previous addresses in the drop-down list box.

Favorites can be used with documents that IE or a program in the Office suite recognizes. One problem with “Favorites” type features is that they are designed for creating permanent links to pages and other documents. For example, a user that is doing some quick “back-and-forth” type navigation between pages may not be interested in saving any of the created Favorites for a longer time. Moreover, the list of Favorites may grow large over time and become increasingly difficult to overview and use, particularly on a computer having a small display device.

### SUMMARY

The invention relates to selectable commands for displaying user interface panels. In a first general aspect, a method of providing that a panel previously displayed on a graphical user interface is displayed again comprises displaying a selected panel on a graphical user interface. While the selected panel is being displayed, a first user input to create a user-selectable command for displaying the selected panel is received. The user-selectable command is thereafter displayed in a menu. A second user input is received upon a first selection of the user-selectable command. The user-selectable command ceases to be displayed in the menu upon receipt of the second user input.

In selected embodiments, a plurality of user-selectable commands is displayed in the menu. At least one of the plurality of user-selectable commands may cease to be displayed in the menu upon occurrence of a predetermined event other than user deletion. At least one of the plurality of user-selectable commands may not cease to be displayed in the menu upon user selection.

In a second general aspect, a graphical user interface on which a previously displayed panel can again be displayed comprises a panel display area wherein a selected panel is displayed, an input control that creates a user-selectable command for displaying the selected panel, and a menu in which at least one user-selectable command created using the input control is displayed, wherein a created user-selectable command ceases to be displayed in the menu upon a first selection of the created user-selectable command.

In a third general aspect, a method of providing that a panel previously displayed on a graphical user interface can be displayed again comprises displaying a selected panel on a graphical user interface. While the selected panel is being displayed, a first user input to create a user-selectable command for displaying the selected panel is received. The user-selectable command is thereafter displayed in a menu. The method comprises ceasing to display the user-selectable command in the menu upon occurrence of a predetermined event other than a user deleting the user-selectable command.

In selected embodiments, a plurality of user-selectable commands is displayed in the menu. At least two of the plurality of user-selectable commands may be associated with panels that belong to different application programs. At least one of the plurality of user-selectable commands may not cease to be displayed in the menu upon user selection.

In selected embodiments, the predetermined event is one selected from the group consisting of: user selection of the user-selectable command, passage of a predetermined amount of time, an application program to which the selected panel belongs being closed, a computer system to which the graphical user interface belongs being shut down, a predetermined number of user-selectable commands being included in the menu after the user-selectable command is created; and combinations thereof.

In a fourth general aspect, a graphical user interface on which a previously displayed panel can again be displayed comprises a panel display area wherein a selected panel is displayed, an input control that creates a user-selectable command for displaying the selected panel, and a menu in which at least one user-selectable command created using the input control is displayed. A created user-selectable command ceases to be displayed in the menu upon occurrence of a predetermined event other than a user deleting the created user-selectable command.

Embodiments of the invention may provide any or all of the following advantages. Improved user navigation between panels may be provided. Convenient user navigation to a previously displayed panel may be provided. A user can return to a previously displayed panel without having to put a permanent Favorite in a Favorites list. A graphical user interface may become more user-friendly. The design of a graphical user interface may be improved. User interaction with small computer devices may be improved. Better management of “Favorites”.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a graphical user interface according to an embodiment of the invention;

FIGS. 2A-2D is an example of operations that can be performed with the graphical user interface shown in FIG. 1;

FIGS. 3A-3C is another example of operations that can be performed with the graphical user interface shown in FIG. 1;

FIGS. 4 and 5 are flow charts of embodiments of the inventive methods; and

FIG. 6 is a block diagram of a computer system.

Like reference numerals in the various drawings indicate like elements.

### DETAILED DESCRIPTION

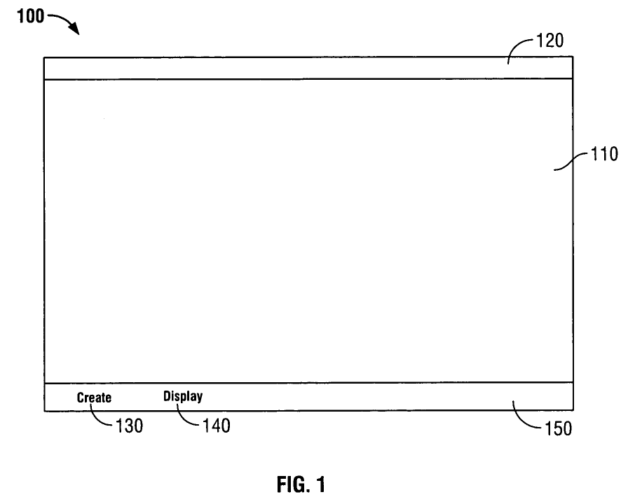

FIG. 1 shows a graphical user interface (GUI) 100 that can be generated on a display device of a computer device. The GUI 100 has a panel display area 110 in which panels can be displayed. The GUI includes a title area 120 where a title of a currently displayed panel may be shown. A wide variety of similar or different panels can be displayed in panel display area 110 including, for example: Internet pages such as web pages and other markup-language pages; word processing documents; directories; images; files; data compilations; electronic forms for data input or output; and screens produced by application programs.

The GUI 100 includes a “Create” input control 130 and a “Display” input control 140. The input controls 130 and 140 may be located in a toolbar area 150 of the GUI 100. As will now be described, the control 130 lets a user create a user-selectable command for displaying a selected panel in the GUI 100; the control 140 lets the user select at least one created command to have its panel be displayed.

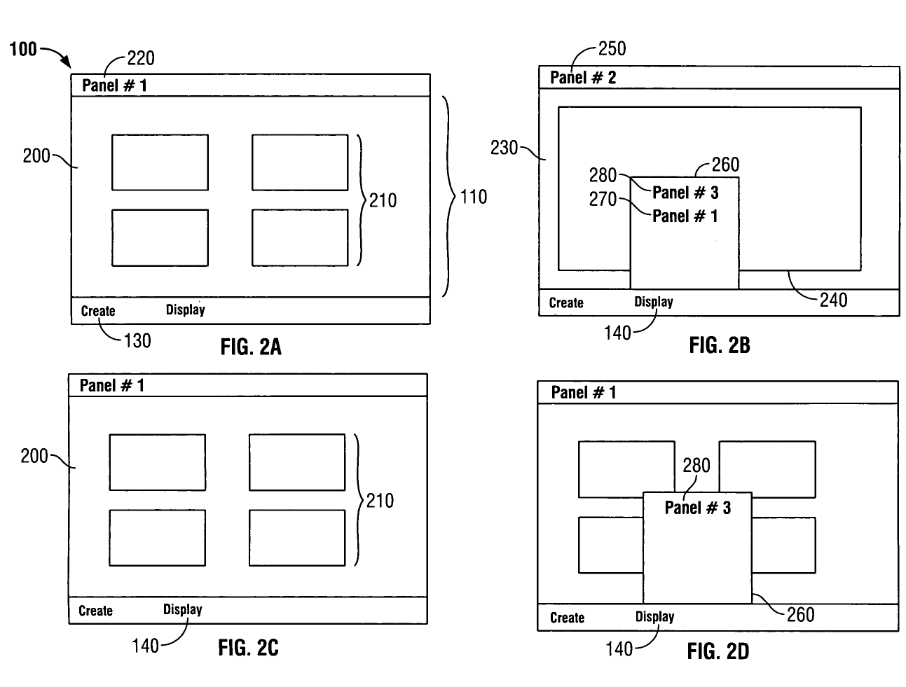

FIGS. 2A-D is an example of operations that can be performed with the GUI 100. In FIG. 2A, a first panel 200 is being displayed in the panel display area 110. The panel 200 may have been selected for display by a user typing its address into a suitable input field or by using a link to the panel 200 on a previously displayed panel. As another example, an application program may specify that the panel 200 is to be displayed, such as when the user advances from one step to the next in a guided process. As yet another example, the panel 200 may be a default panel that initially appears when the GUI 100 is being used.

Panel 200 is characterized by its content 210 and title 220. The content 210 may include one or more input fields that prompt the user to enter data. Assume, now, that the user needs additional information that is not available on panel 200 and therefore decides to visit another panel before finishing the data entry in panel 200. The user wants a convenient way of later returning to the panel 200. She therefore selects the “Create” input control 130 in the GUI 100. The control 130 may be an icon or any other control by which the user can make a predefined input. In a desktop or laptop implementation, the user may select the control 130 with a pointer device. In an implementation for a handheld computer device, one of the keys on the device keypad may be assigned to the control 130, such that the user can select the “Create” control with the assigned button. When the computer receives the input associated with the user selecting the control 130, a user-selectable control for displaying the first panel 200 is created, which will be described with reference to the next figure.

FIG. 2B shows a second panel 230—to which the user has navigated to seek additional information-displayed in the panel display area 110. The user may have navigated directly from the panel 200 to the panel 230, or may have passed by any number of intermediate panels on the way. Moreover, the user may have shut down an application program or the computer device to which the GUI 100 belongs after leaving the first panel 200. The second panel 230 is characterized by its content 240 and its title 250.

In this example, the user finds the information she needs on panel 230 and now wishes to go back to the first panel 200. The user therefore selects the “Display” input control 140 which, like the control 130, may be a selectable icon or other input control. Selecting the control 140 causes a menu 260 to be displayed in the GUI 100. The menu 260 can include one or more user-selectable commands for displaying panels. Currently, the menu 260 includes user-selectable commands 270 and 280.

The user-selectable command 270 is included in the menu 260 in response to the user selecting the “Create” input control 130 as was described with regard to FIG. 2A. The command 270 in this example has the name “Panel #1,” which is identical to the title 220 for the first panel 100. Selecting the command 270 causes the first panel 200 to be displayed in the GUI 100. The user-selectable command 280, in contrast, was not created together with the command 270. It has the name “Panel # 3” and relates to another panel that can be displayed in the GUI.

The user now selects the command 270 using a pointer device or other input device. Receiving an input from this selection triggers the computer to display the first panel 200 in the GUI, as shown in FIG. 2C. The user is now back where she previously left off. If the user had entered information in the content 210, that information is preferably preserved while the user navigates to the second panel 200 such that the user need not re-enter it upon returning. For example, if the first panel 200 is generated by a stateful application, the computer can store the state of the application upon creating the command 270. When the command 270 is executed, the current version of the panel 200 can be re-created using the stored state.

The user-selectable command 270 ceases to be displayed in the menu 260 upon being selected by the user. That is, when the computer receives the input generated by the user's selection of the command 270, the computer ceases to display the command in the menu 260. In an implementation where the menu 260 is not continuously displayed on the graphical user interface, the command ceasing to be displayed may be noticeable to the user the next time the user opens the menu 260. FIG. 2D shows the GUI 100 as it may appear if the user selects the control 140 after using the command 270 to return to the panel 200. The command 270 no longer appears in the menu 260. Thus, the controls 130 and 140 may provide a convenient way for a user to mark a panel before navigating elsewhere (or shutting down the system) and to later return to the same panel. This may allow the user to conveniently return to the previously displayed panel without having to create a permanent Favorite—which could otherwise clutter the Favorites list and make it more difficult for the user to find a specific Favorite.

In contrast to the command 270, the command 280—which the user did not select-remains in the menu 260. The user-selectable command 280 may be similar to the command 270. That is, it may have been created using the control 130 (while the panel identified by the command 280 was being displayed). The “Panel # 3” may belong to the same or a different application program than does the panel 200. As another example, the command 280 may be a user-selectable command that does not cease to be displayed in the menu 260 upon being selected. The command 280 may be a “Favorite” or an address bar entry as described in the Background section above. In such implementations, the command 270 may be included in a Favorite menu, or a Favorite (command 280) may be included in a menu that has at least one command 270, to name just two possibilities. As yet another example, the command 280 may be a command that ceases to be displayed in the menu 260 upon the occurrence of a predetermined event, as will now be described.

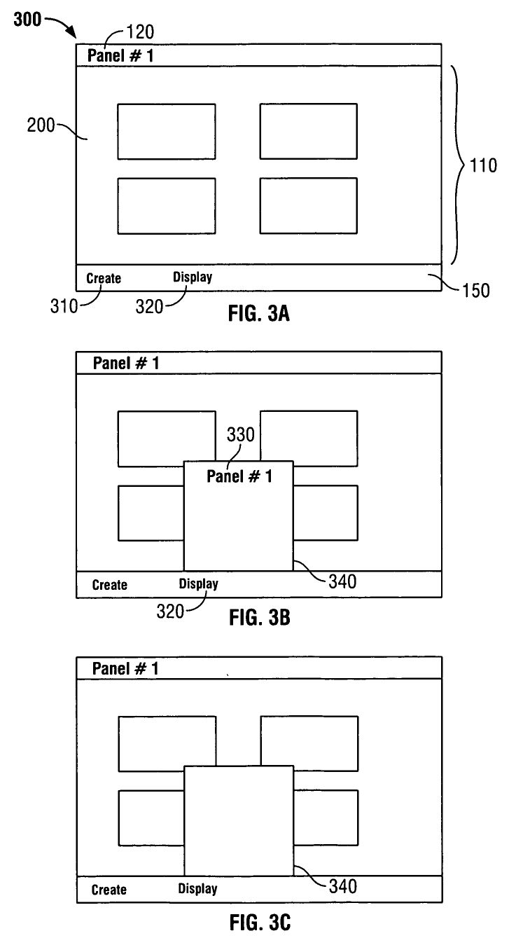

FIGS. 3A-C are another example of operations relating to a user-selectable command. FIG. 3A shows a GUI 300 that, similarly to the GUI 100, includes the panel display area 110, the title area 120 and the toolbar area 150. Like the GUI 100 in FIG. 2A, the GUI 300 is currently displaying the first panel 200 in the panel display area 110. The GUI 300 includes “Create” and “Display” input controls 310 and 320, respectively.

Assume that the user selects the control 310 while the first panel 200 is being displayed in the GUI. In response, a user-selectable command 330 will be included in a menu 340, as shown in FIG. 3B. The menu 340 may be displayed upon user selection of the control 320.

The command 330 ceases to be displayed in the menu 340 upon the occurrence of a predetermined event other than a user deleting the command. That is, when the predetermined event occurs, the computer will cease to display the command 330 in the menu 340. In an implementation where the menu 340 is visible only upon user action, the command ceasing to be displayed in the menu may be noticeable to the user the next time the user views the menu.

Many different events can be used to trigger the disappearance of the command 330 from the menu 340. Examples include: a user closing the application program to which the first panel 200 belongs; a user shutting down the computer with which the GUI 300 is being used; a certain amount of time passing; a certain number of user-selectable commands being included in the menu 340 after the command 330 is created; and combinations thereof.

FIG. 3C shows the GUI 300 upon occurrence of the predetermined event, where the command 330 is no longer displayed in the menu 340. For clarity, FIG. 3B only shows a single user-selectable command but could include more than one. Had there been other commands in the menu 340, they may cease to be displayed upon the same predetermined event or they may remain there after the command 330 disappears. If they do not cease to be displayed with the command 330, they may remain indefinitely or disappear upon another predetermined event. For example, one or more of the other commands may cease to be displayed upon user selection. As another example, the menu 340 may include a “Favorite” command or an address bar entry.

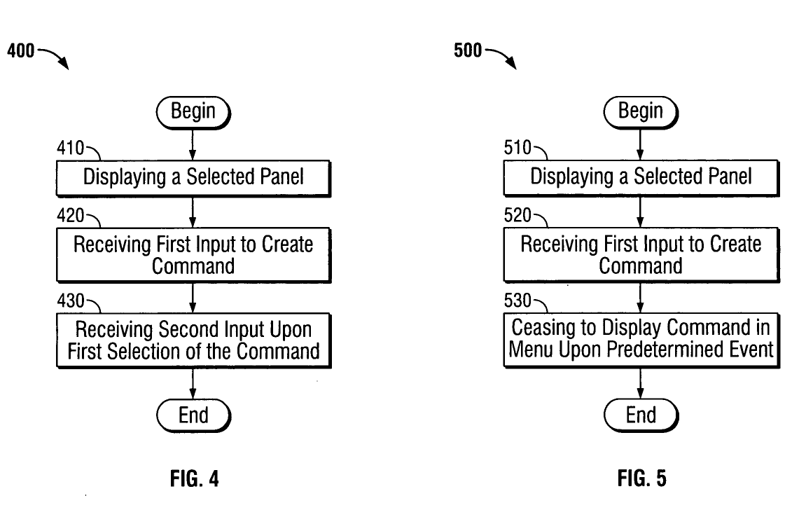

FIG. 4 is a flow chart of a method 400 according to an embodiment of the invention. Preferably, the method 400 is performed in a computer system. For example, a computer program product can include instructions that cause a processor to perform the steps of method 400. The following steps are included in method 400:

Displaying, in step 410, a selected panel on a graphical user interface. For example, the first panel 200 may be displayed on the GUI 100.

In step 420, receiving a first user input, while the selected panel is being displayed, to create a user-selectable command for displaying the selected panel, the user-selectable command thereafter being displayed in a menu. For example, the user may select the input control 130 to create the command 270 to be displayed in the menu 260.

Receiving, in step 430, a second user input upon a first selection of the user-selectable command. The user-selectable command ceases to be displayed in the menu upon receipt of the second user input. For example, the command 270 may cease to be displayed in the menu 260 the first time the user selects it.

FIG. 5 is a flow chart of a method 500 according to an embodiment of the invention. Preferably, the method 500 is performed in a computer system. For example, a computer program product can include instructions that cause a processor to perform the steps of method 500. The following steps are included in method 500:

Displaying, in step 510, a selected panel on a graphical user interface. For example, the first panel 200 may be displayed on the GUI 100.

In step 520, receiving a first user input, while the selected panel is being displayed, to create a user-selectable command for displaying the selected panel, the user-selectable command thereafter being displayed in a menu. For example, the user may select the input control 310 to create the command 330 to be displayed in the menu 340.

Ceasing to display, in step 530, the user-selectable command in the menu upon occurrence of a predetermined event other than a user deleting the user-selectable command. For example, the command 330 may cease to be displayed in the menu 340 upon the predetermined event. The command ceasing to be displayed may be noticeable to the user the next time the user views the menu 340.

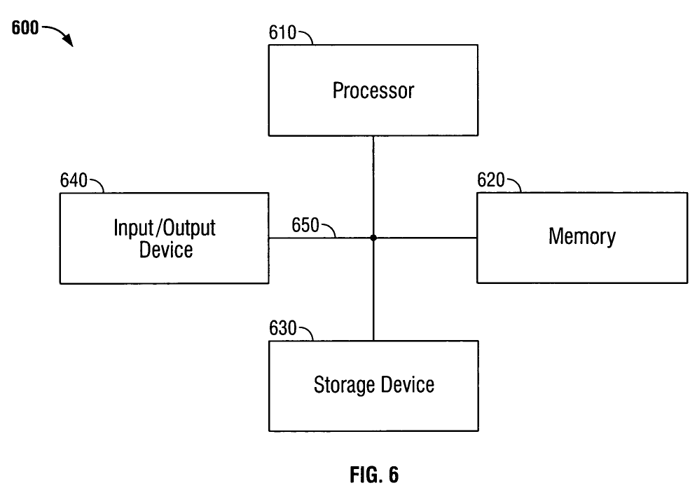

FIG. 6 is a block diagram of a computer system 600 that can be used in the operations described above, according to one embodiment. The system 600 includes a processor 610, a memory 620, a storage device 630 and an input/output device 640. Each of the components 610, 620, 630 and 640 are interconnected using a system bus 650. The processor 610 is capable of processing instructions for execution within the system 600. In one embodiment, the processor 610 is a single-threaded processor. In another embodiment, the processor 610 is a multi-threaded processor. The processor 610 is capable of processing instructions stored in the memory 620 or on the storage device 630 to display graphical information for a user interface on the input/output device 640.

The memory 620 stores information within the system 600. In one embodiment, the memory 620 is a computer-readable medium. In one embodiment, the memory 620 is a volatile memory unit. In another embodiment, the memory 620 is a non-volatile memory unit.

The storage device 630 is capable of providing mass storage for the system 600. In one embodiment, the storage device 630 is a computer-readable medium. In various different embodiments, the storage device 630 may be a floppy disk device, a hard disk device, an optical disk device, or a tape device.

The input/output device 640 provides input/output operations for the system 600. The input/output device 640 may include a keyboard and/or pointing device. The input/output device 640 may include a display device. For example, the GUI 100 described with reference to FIGS. 2A-D and 3A-C above may be produced by the input/output device 640.

In one embodiment, the computer system 600 is a handheld computer. In another embodiment, the computer system 600 is a laptop computer or a desktop computer. In yet another embodiment, the computer system 600 is a cellular telephone or other wireless communication device.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

1. A method of providing that a panel previously displayed on a graphical user interface is displayed again, the method comprising:
displaying a selected panel on a graphical user interface;
receiving, while the selected panel is being displayed, a first user input to create a user-selectable command for displaying the selected panel, the user-selectable command thereafter being displayed in a menu; and
receiving a second user input upon a first selection of the user-selectable command, wherein the user-selectable command ceases to be displayed in the menu upon receipt of the second user input.

2. The method of claim 1, wherein the menu is not continuously displayed on the graphical user interface, and wherein a user can cause the menu to be displayed by selecting an input control for the menu.

3. The method of claim 2, wherein the user-selectable command ceasing to be displayed in the menu is noticeable to the user at a first time the menu is displayed after the second user input is received.

4. The method of claim 1, wherein the selected panel belongs to an application program, and wherein the application program is being executed when the first user input is received and thereafter closed before the second user input is received.

5. The method of claim 1, wherein a plurality of user-selectable commands is displayed in the menu.

6. The method of claim 5, wherein at least two of the plurality of user-selectable commands are associated with panels that belong to different application programs.

7. The method of claim 5, wherein at least one of the plurality of user-selectable commands ceases to be displayed in the menu upon occurrence of a predetermined event other than user deletion.

8. The method of claim 5, wherein at least one of the plurality of user-selectable commands does not cease to be displayed in the menu upon user selection.

9. A computer program product tangibly embodied in an information carrier, the computer program product including instructions that, when executed, cause a processor to perform operations comprising:
display a selected panel on a graphical user interface;
receive, while the selected panel is being displayed, a first user input to create a user-selectable command for displaying the selected panel, the user-selectable command thereafter being displayed in a menu; and
receive a second user input upon a first selection of the user-selectable command, wherein the user-selectable command ceases to be displayed in the menu upon receipt of the second user input.

10. The computer program product of claim 9, wherein the operations further comprise:
display a plurality of user-selectable commands in the menu.

11. The computer program product of claim 10, wherein at least two of the plurality of user-selectable commands are associated with panels that belong to different application programs.

12. The computer program product of claim 10, wherein at least one of the plurality of user-selectable commands ceases to be displayed in the menu upon occurrence of a predetermined event other than user deletion.

13. The computer program product of claim 10, wherein at least one of the plurality of user-selectable commands does not cease to be displayed in the menu upon user selection.

14. A computer program product tangibly embodied in an information carrier, the computer program product including instructions that, when executed, generate on a display device a graphical user interface on which a previously displayed panel can again be displayed, the graphical user interface comprising:
a panel display area wherein a selected panel is displayed;
an input control that creates a user-selectable command for displaying the selected panel; and
a menu in which at least one user-selectable command created using the input control is displayed, wherein a created user-selectable command ceases to be displayed in the menu upon a first selection of the created user-selectable command.

15. The computer program product of claim 14, wherein a plurality of user-selectable commands is displayed in the menu.

16. The computer program product of claim 15, wherein at least two of the plurality of user-selectable commands are associated with panels that belong to different application programs.

17. The computer program product of claim 15, wherein at least one of the plurality of user-selectable commands ceases to be displayed in the menu upon occurrence of a predetermined event other than user deletion.

18. The computer program product of claim 15, wherein at least one of the plurality of user-selectable commands does not cease to be displayed in from the menu upon user selection.

19. A method of providing that a panel previously displayed on a graphical user interface can be displayed again, the method comprising:
displaying a selected panel on a graphical user interface;
receiving, while the selected panel is being displayed, a first user input to create a user-selectable command for displaying the selected panel, the user-selectable command thereafter being displayed in a menu; and
ceasing to display the user-selectable command in the menu upon occurrence of a predetermined event other than a user deleting the user-selectable command.

20. The method of claim 19, wherein the menu is not continuously displayed on the graphical user interface, and wherein the user can cause the menu to be displayed by selecting an input control for the menu.

21. The method of claim 20, wherein the user-selectable command ceasing to be displayed in the menu is noticeable to the user at a first time the menu is displayed after the second user input is received.

22. The method of claim 19, wherein the selected panel belongs to an application program, and wherein the application program is being executed when the first user input is received and thereafter closed before the second user input is received.

23. The method of claim 19, wherein a plurality of user-selectable commands is displayed in the menu.

24. The method of claim 23, wherein at least two of the plurality of user-selectable commands are associated with panels that belong to different application programs.

25. The method of claim 23, wherein at least one of the plurality of user-selectable commands does not cease to be displayed in the menu upon user selection.

26. The method of claim 19, wherein the predetermined event is one selected from the group consisting of: user selection of the user-selectable command, passage of a predetermined amount of time, an application program to which the selected panel belongs being closed, a computer system to which the graphical user interface belongs being shut down, a predetermined number of user-selectable commands being included in the menu after the user-selectable command is created; and combinations thereof.

27. A computer program product tangibly embodied in an information carrier, the computer program product including instructions that, when executed, cause a processor to perform operations comprising:
display a selected panel on a graphical user interface;
receive, while the selected panel is being displayed, a first user input to create a user-selectable command for displaying the selected panel, the user-selectable command thereafter being displayed in a menu; and
cease to display the user-selectable command in the menu upon occurrence of a predetermined event other than a user deleting the user-selectable command.

28. The computer program product of claim 27, wherein the operations further comprise:
display a plurality of user-selectable commands in the menu.

29. The computer program product of claim 28, wherein at least two of the plurality of user-selectable commands are associated with panels that belong to different application programs.

30. The computer program product of claim 28, wherein at least one of the plurality of user-selectable commands does not cease to be displayed in the menu upon user selection.

31. The computer program product of claim 27, wherein the predetermined event is one selected from the group consisting of: user selection of the user-selectable command, passage of a predetermined amount of time, an application program to which the selected panel belongs being closed, a computer system to which the graphical user interface belongs being shut down, a predetermined number of user-selectable commands being included in the menu after the user-selectable command is created; and combinations thereof.

32. A computer program product tangibly embodied in an information carrier, the computer program product including instructions that, when executed, generate on a display device a graphical user interface on which a previously displayed panel can again be displayed, the graphical user interface comprising:
a panel display area wherein a selected panel is displayed;
an input control that creates a user-selectable command for displaying the selected panel; and
a menu in which at least one user-selectable command created using the input control is displayed, wherein a created user-selectable command ceases to be displayed in the menu upon occurrence of a predetermined event other than a user deleting the created user-selectable command.

33. The computer program product of claim 32, wherein a plurality of user-selectable commands is displayed in the menu.

34. The computer program product of claim 33, wherein at least two of the plurality of user-selectable commands are associated with panels that belong to different application programs.

35. The computer program product of claim 33, wherein at least one of the plurality of user-selectable commands does not cease to be displayed in the menu upon user selection.

36. The computer program product of claim 32, wherein the predetermined event is one selected from the group consisting of: user selection of the user-selectable command, passage of a predetermined amount of time, an application program to which the selected panel belongs being closed, a computer system to which the graphical user interface belongs being shut down, a predetermined number of user-selectable commands being included in the menu after the user-selectable command is created; and combinations thereof.
